(19) United States
(12) Patent Application Publication
(10) Pub. No.: US 2024/0349708 A1
(43) Pub. Date: Oct. 24, 2024

(54) Pre-Cut Round Strand Skirt Material

(71) Applicant: Jeffrey Shelton, Cullman, AL (US)

(72) Inventor: Jeffrey Shelton, Cullman, AL (US)

(21) Appl. No.: 18/534,965

(22) Filed: Dec. 11, 2023

Related U.S. Application Data
(60) Provisional application No. 63/497,304, filed on Apr. 20, 2023.

(51) Int. Cl. A01K 85/00

(52) U.S. Cl. CPC A01K 85/1821; A01K 85/1897

(57) ABSTRACT

A round strand skirt material device to enhance the efficiency of producing fishing lures and flies. In one embodiment, the device comprises pre-cut flat layers of skirt material, each fused at opposite ends to secure individual cylindrical strands, obviating the need for manual separation. In another embodiment, the device takes the form of a roll, featuring serially connected pre-cut portions with detachable, perforated lines. These portions house separated round strands, promoting easy detachment and utilization. In some embodiments, the device can be used with barrel tools to form lures and flies. The device of the present invention provides anglers a time-saving tool adaptable to different manufacturing techniques, contributing to efficient and dynamic fishing lure and fly production.

### CROSS-REFERENCE TO RELATED APPLICATION

The present application claims priority to, and the benefit of, U.S. Provisional Application No. 63/497,304, which was filed on Apr. 20, 2023, and is incorporated herein by reference in its entirety.

### FIELD OF THE INVENTION

The present invention generally relates to the field of fishing skirts and lures. More specifically, the present invention relates to a novel device capable of creating fishing skirts using round strand skirt material. The device includes a flat layer of round strand skirt material that has opposite ends fused together. The device can be used with a barrel type skirt tool to create lures and flies. The device includes individual and separate pre-cut round strands. Accordingly, the present disclosure makes specific reference thereto. Nonetheless, it is to be appreciated that aspects of the present invention are also equally applicable to other like applications, devices, and methods of manufacture.

### BACKGROUND

By way of background, round skirt material is the most commonly used type of material for making fishing skirts. Fishing skirts are components used in fishing lures to mimic the appearance of baitfish or other prey. Traditionally, fishing skirts are made from strands of material that are attached to the lure's head or body and create a visually appealing and lifelike movement in the water. Fishing skirts are constructed by attaching multiple strands to a central point on the lure. The strands extend outward, creating a skirt-like appearance when in water.

However, the process of creating a fishing skirt is laborious, time-consuming and can be frustrating. Based on the design and size of a lure, skirt strands of the desired length are measured and manually cut by an individual. Each strand is individually cut meticulously. Commonly, the skirt material comes in bundles or has multiple strands fused together, and each individual strand needs to be separated from the bundle. Handling each strand individually, measuring, cutting, and attaching to a lure takes a significant amount of time which leaves little time for other tasks related to fishing lure assembly or other aspects of fishing preparation. Commercially, the traditional round skirt material reduces the efficiency of making fishing skirts and people desire an improved way of quickly and effectively making fishing skirts.

Therefore, there exists a long felt need in the art for a round strand skirt material device that offers several advantages over conventional fishing lure and fly production methods. Additionally, there is a long felt need in the art for round strand skirt material that is precut into lengths for easily producing fishing lures. Moreover, there is a long felt need in the art for precut skirt strips/layers material that makes creating lures and flies easier and faster. Further, there is a long felt need in the art for round strand skirt material that has separated strands and comes ready-made in specific lengths. Furthermore, there is a long felt need in the art for an improved round strand skirt material that eliminates the need to purchase round strand skirt material rolls that need to be cut and manually separated. Finally, there is a long felt need in the art for pre-cut round strand skirt material that provides separate strands which makes the creation of fishing lures and flies much more efficient and convenient.

The subject matter disclosed and claimed herein, in one embodiment thereof, comprises a round strand skirt material device for preparing a fishing skirt for lures and flies. The device provides individual strands that are not required to be measured, cut, nor separated. The round strand skirt material device further comprising a flat layer or tab of skirt material having a plurality of individual cylindrical strands of a specific length, each strand being constructed from materials including silicone, rubber, or synthetic fibers, the flat layer or tab having two opposite ends that are fused together, the pre-cut round strand skirt material device available in different colors to accommodate the requirements of different users, wherein the round strand skirt material device is used with a barrel type skirt tool to create lures and flies. The device can be used to attach to a hook of a lure and can also be available in the form of a roll.

In this manner, the pre-cut round strand skirt material device of the present invention accomplishes all of the forgoing objectives and provides users with a device capable of creating fishing skirts using round strand skirt material obviating the need to purchase round strand skirt material that needs to be cut and separated. The round strand skirt material having precut lengths, with each strand separated ahead of time, makes the creation of fishing lures and flies much more efficient and convenient.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its purpose is to present some general concepts in a simplified form as a prelude to the more detailed description that is presented later.

The subject matter disclosed and claimed herein, in one embodiment thereof, comprises a round strand skirt material device for preparing a fishing skirt for lures and flies. The round strand skirt material device further comprising round skirt material layers or tabs having a plurality of individual cylindrical strands, each strand being constructed from materials including silicone, rubber, or synthetic fibers, the round skirt material layers or tabs having two opposite ends that are fused together, the pre-cut round strand skirt material device available in different predeterminable lengths and colors to accommodate the requirements of different users, wherein the round strand skirt material device is used with a barrel type skirt tool to create lures and flies.

In yet another embodiment, a method for utilizing round skirt material layers or tabs in combination with a barrel type skirt tool for assembling fishing lures and flies is described. The method comprising the steps of passing the skirt material device through an eye of the barrel type skirt tool, the skirt material includes individual round strands, passing a collar over the skirt material device to hold it in place within the barrel type skirt tool, making a cut in the skirt material device, wherein round strands being individually and securely held by fused ends of the skirt material device prior to the cut, and being distributed outward from the cut to create a skirt-like appearance in the fishing lure or fly.

In a further embodiment, round skirt material layers or tabs device for facilitating the assembly of fishing lures and flies is disclosed. The device comprising a roll comprising a plurality of serially connected pre-cut skirt material portions, each individual pre-cut skirt material portion includes individual and separate round strands, the pre-cut skirt material portions are of the same size or different sizes, and each of the pre-cut skirt material portions being detachable from the roll along a perforation line.

In another aspect of the present invention, a round strand skirt material layer or tab device to enable the process of making fishing lures and flies to become more efficient is disclosed. The device is comprised of a flat layer or tab of round strand skirt material, the layer or tab has two opposite ends, the opposite ends are fused together, when the ends of the layers are cut off, individual strands are separated and thus makes the creation of fishing lures and flies much more efficient and convenient by obviating measuring, cutting, and separating the individual strands.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a pre-cut round strand skirt material layer or tab device of the present invention in accordance with the disclosed architecture;

FIG. 2 illustrates a perspective view of use of the pre-cut round strand skirt material layer or tab device of FIG. 1 in accordance with the disclosed structure;

FIG. 3 illustrates another embodiment of the pre-cut round strand skirt material layer or tab device of the present invention in accordance with the disclosed structure; and

FIG. 4 illustrates yet another embodiment of the pre-cut round strand skirt material layer or tab device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a round strand skirt material layers or tabs that offers several advantages over conventional fishing lure and fly production methods. Additionally, there is a long felt need in the art for round strand skirt material that is precut into lengths for easily producing fishing lures. Moreover, there is a long felt need in the art for precut skirt strips, layers, or tabs of material that makes creating lures and flies easier and faster. Further, there is a long felt need in the art for round strand skirt material that has separated strands and comes ready-made in specific lengths. Furthermore, there is a long felt need in the art for an improved round strand skirt material that eliminates the need to purchase round strand skirt material rolls that need to be cut and manually separated. Finally, there is a long felt need in the art for pre-cut round strand skirt material (i.e., layers or tabs) that provides separate strands which makes the creation of fishing lures and flies more efficient and convenient.

The present invention, in one exemplary embodiment, is a round strand skirt material device to enable the process of making fishing lures and flies more efficient. The device is comprised of a flat layer or tab of round strand skirt material, the layer or tab has two opposite ends, the opposite ends are fused together, when the ends of the layers (or tabs) are cut off, individual strands are separated and thus makes the creation of fishing lures and flies much more efficient and convenient by obviating measuring, cutting, and separating the individual strands.

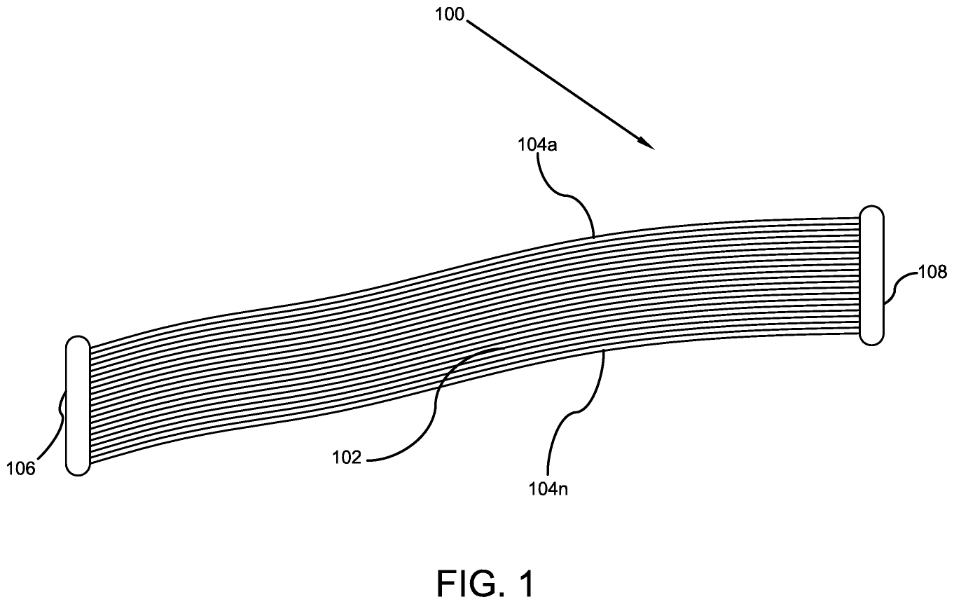

Referring initially to the drawings, FIG. 1 illustrates a perspective view of one embodiment of pre-cut round strand (i.e., circular cross section) skirt material device of the present invention in accordance with the disclosed architecture. The pre-cut round strand (i.e., circular cross section) skirt material device (i.e., layers or tabs) 100 of the present invention is designed to make the process of making fishing lures and flies more efficient, quick, and convenient. More specifically, the round strand skirt material 100 includes a flat layer or tab 102 of skirt material. The flat layer or tab 102 has a plurality of individual cylindrical strands 104a-n, each strand can be made from materials selected from the group consisting of silicone, rubber, and synthetic fibers. The flat layer or tab 102 has two opposite ends 106, 108 which are fused together. Preferably, the opposite ends 106, 108 are sewn together or can be fused together using an adhesive. Each strand is individually fused to the opposite ends 106, 108, thereby the device 100 maintains the individual and separate strands. The pre-cut round strand skirt material device 100 can come in different predeterminable lengths and colors to meet requirements of different users.

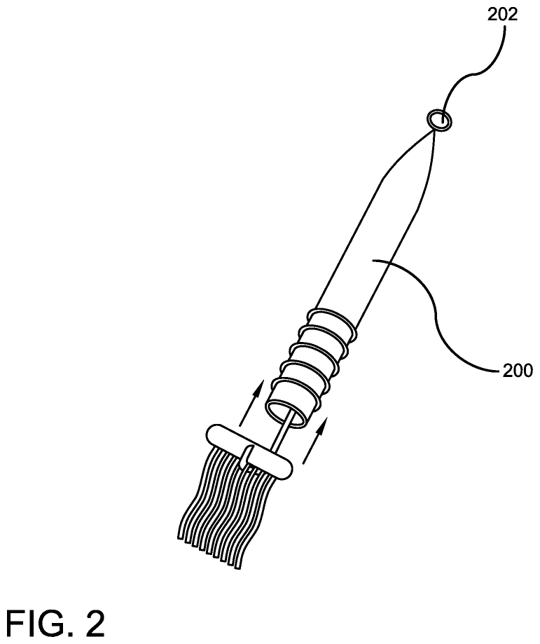

FIG. 2 illustrates a perspective view of use of the pre-cut round strand (i.e., circular cross section) skirt material device 100 of FIG. 1 in accordance with the disclosed structure. The skirt material device 100 is passed through an eye 202 of a barrel type skirt tool 200 and a collar 204 is passed over the skirt material device 100. Then, a cut 206 is made in the skirt material device 100 for releasing already separated round strands 104.

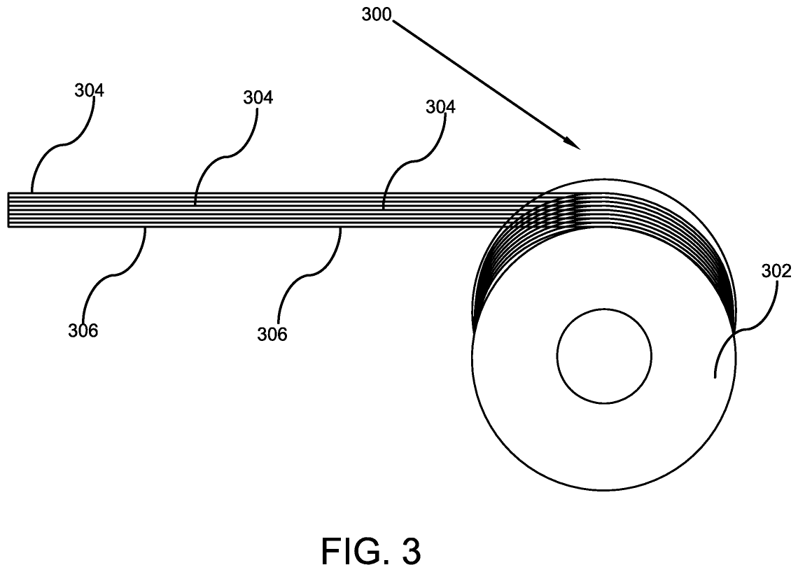

FIG. 3 illustrates another embodiment of the pre-cut round strand (i.e., circular cross section) skirt material device of the present invention in accordance with the disclosed structure. As illustrated, in the present embodiment, the round strand skirt material device 300 is in the form of a roll 302 formed of serially connected pre-cut skirt material portions 304. Each individual pre-cut skirt material portions 304 includes individual and separate round strands (similar to FIG. 1) and the portions 304 can be of the same size or of different sizes. Further, an individual pre-cut skirt material portion can be easily detached from the roll 302 along a perforation line 306. Each pair of consecutive portions 304 are attached using the perforation line 306, enabling a user to easily access the portion 304 for use to make a fishing lure.

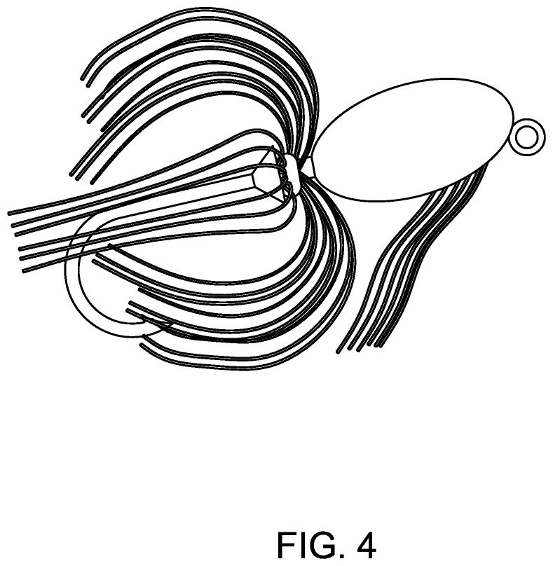

FIG. 4 illustrates yet another embodiment of the pre-cut round strand skirt material device of the present invention in accordance with the disclosed structure. In the present embodiment, the fused ends 402, 404 of the pre-cut round strand skirt material device 400 has a hook 406 integrated thereon. The hook 406 can be directly attached to an attachment point 408 such as a treble hook of a lure. The fishing skirt material device 400 can be cut at a desired position 410 across the length of the skirt material device 400 using scissors for the individual strands to naturally fan out to function as a conventional fishing skirt.

It will be apparent to a person skilled in the art that the device 100, 300, 400 enhances the process of manufacturing fishing lures and flies. The device helps save time, reduce effort, and potentially increase productivity in the production of these fishing-related items. The material consists of individual cylindrical strands, made from materials selected from the group consisting of silicone, rubber, and synthetic fibers. By fusing the ends of the strands, the strands are held in a specific alignment, making it easier to work with and the strands do not unravel during making of lures and flies.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pre-cut round strand skirt material device”, “skirt material device”, “fishing skirt material device”, “tool”, and “device” are interchangeable and refer to the pre-cut round strand skirt material device 100, 300, 400 of the present invention.

Notwithstanding the forgoing, the pre-cut round strand skirt material device 100, 300, 400 of the present invention can be of any suitable size and configuration as is known in the art without affecting the overall concept of the invention, provided that it accomplishes the above stated objectives. One of ordinary skill in the art will appreciate that the pre-cut round strand skirt material device 100, 300, 400 as shown in the FIGS. are for illustrative purposes only, and that many other sizes and shapes of the pre-cut round strand skirt material device 100, 300, 400 are well within the scope of the present disclosure. Although the dimensions of the pre-cut round strand skirt material device 100, 300, 400 are important design parameters for user convenience, the pre-cut round strand skirt material device 100, 300, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A skirt material device for fishing lures, the skirt material device comprising:
a skirt material device having a round strand skirt material including a wrap of a plurality of individual strands;
wherein said wrap of said plurality of individual strands comprising a flat layer of skirt material;
wherein said flat layer of skirt material having a plurality of individual cylindrical strands;
wherein each strand is a material selected from the group consisting of a silicone, a rubber, and a synthetic fiber;
wherein each said plurality of individual cylindrical strands having two opposite ends; and
further wherein said opposite ends are fused together with an adhesive.

2. The skirt material device for fishing lures of claim 1, wherein said plurality of individual cylindrical strands having a predeterminable length.

3. The skirt material device for fishing lures of claim 2, wherein said plurality of individual cylindrical strands are pre-cut.

4. The skirt material device for fishing lures of claim 3, wherein said plurality of individual cylindrical strands having a circular cross section.

5. The skirt material device for fishing lures of claim 4, wherein said plurality of individual cylindrical strands comprising separate strands.

6. The skirt material device for fishing lures of claim 5, wherein said skirt material device is in the form of a roll having serially connected said plurality of individual cylindrical strands.

7. The skirt material device for fishing lures of claim 6, wherein said serially connected having separable perforations between adjacent said plurality of individual cylindrical strands.

8. A skirt material device for fishing lures, the skirt material device comprising:
a skirt material device having a round strand skirt material including a wrap of a plurality of individual strands;
wherein said wrap of said plurality of individual strands comprising a flat tab of skirt material;
wherein said flat tab of skirt material having a plurality of individual cylindrical strands;
wherein each strand is a material selected from the group consisting of a silicone, a rubber, and a synthetic fiber;
wherein each said plurality of individual cylindrical strands having two opposite ends;
wherein said opposite ends are fused together with an adhesive; and
further wherein said plurality of individual cylindrical strands having a circular cross section.

9. The skirt material device for fishing lures of claim 8, wherein said plurality of individual cylindrical strands having a predeterminable length.

10. The skirt material device for fishing lures of claim 8, wherein said plurality of individual cylindrical strands are pre-cut.

11. The skirt material device for fishing lures of claim 8, wherein said plurality of individual cylindrical strands comprising separate strands.

12. The skirt material device for fishing lures of claim 8, wherein said skirt material device is in the form of a roll having serially connected said plurality of individual cylindrical strands.

13. The skirt material device for fishing lures of claim 12, wherein said serially connected having separable perforations between adjacent said plurality of individual cylindrical strands.

14. A skirt material device for fishing lures, the skirt material device comprising:
a skirt material device having a round strand skirt material including a wrap of a plurality of individual strands;
wherein said wrap of said plurality of individual strands comprising a flat layer of skirt material;
wherein each strand is a material selected from the group consisting of a silicone, a rubber, and a synthetic fiber;
wherein each said plurality of individual cylindrical strands having two opposite ends;
wherein said opposite ends are fused together; and
further wherein said skirt material device is in the form of a roll having serially connected said plurality of individual cylindrical strands.

15. The skirt material device for fishing lures of claim 14, wherein said fusing together comprising an adhesive.

16. The skirt material device for fishing lures of claim 14, wherein said plurality of individual cylindrical strands having a predeterminable length.

17. The skirt material device for fishing lures of claim 14, wherein said plurality of individual cylindrical strands are pre-cut.

18. The skirt material device for fishing lures of claim 14, wherein said plurality of individual cylindrical strands comprising separate strands.

19. The skirt material device for fishing lures of claim 14, wherein said serially connected having separable perforations between adjacent said plurality of individual cylindrical strands.

20. The skirt material device for fishing lures of claim 14, wherein said plurality of individual cylindrical strands having a circular cross section.
